(19) United States
(12) Patent Application Publication
(10) Pub. No.: US 2025/0002765 A1
(43) Pub. Date: Jan. 2, 2025

(54) OPTICAL ADHESIVE COMPOSITION AND OPTICAL ADHESIVE FILM PREPARED THEREFROM

(71) Applicant: BenQ Materials Corporation, Taoyuan (TW)

(72) Inventors: TETSUYA OKAZAKI, Taoyuan (TW); WEN-HSIN YANG, Taoyuan (TW); CHUNG-CHING TSENG, Taoyuan (TW)

(73) Assignee: BenQ Materials Corporation, Taoyuan (TW)

(21) Appl. No.: 18/501,091

(22) Filed: Nov. 3, 2023

(30) Foreign Application Priority Data
Jun. 30, 2023 (TW) 112124586

(51) Int. Cl. C09J 133/08; C08F 220/18; C09J 7/30

(52) U.S. Cl. CPC C09J 133/08; C08F 220/1808; C09J 7/30; C09J 2433/00

(57) ABSTRACT

A low thermal shrinkage separator and a method for manufacturing thereof is disclosed. The method comprises providing a porous polyolefin substrate with a plurality of porous structures on surfaces and interiors thereof, and applying a prescursor solution comprising a titanium alkoxide and hexamethyldisilazane and subsequently applying an alcohol solution to form a low thermal shrinkage thin film formed on the surfaces and the sidewalls of the porous structures of the porous polyolefin substrate. The present method can enhance the low thermal shrinkage and electrolyte wettability of the separator.

### CROSS-REFERENCE TO RELATED APPLICATION

This application claims the priority benefit of Taiwanese Application Serial Number 112124586, filed on Jun. 30, 2023 which is incorporated herein by reference.

### BACKGROUND OF THE INVENTION

### Field of the Invention

The present invention relates to an optical adhesive composition and an optical adhesive film prepared therefrom, and more particularly to an optical adhesive film for a display device, having a good step filling ability for bonding interface between a polymer optical film and a cover glass at room temperature, and a stress relaxation property under high temperature or external force.

### Description of Related Art

As the display devices are used in various fields, either liquid crystal display device or electroluminescent display device, display devices require glass cover plates on the outmost surface for protecting the displays and improve the appearance quality. Since the peripheral part of the inner surface of the glass cover plate is usually ink-printed an light-shielding frame area with a thickness and the surface of the display device generally has an optical film or a functional film for obtaining better optical performance, the modulus between the glass cover plate and the polymer film is significant different, the optical adhesive for bonding the glass cover plate to the surface of the display device is required to provide a step filling property at room temperature better than conventional pressure sensitive adhesives in order to avoid air bubbles generated in the bonding interface to affect the adhesion and the appearance quality. In addition, when the display is subjected to an external force to be bent or is under a high-temperature environment, the display may produce optical defects such as uneven light spots (mura) due to the transverse shear stress resulting from the different stress between the glass cover plate and film layers. Thus, the optical adhesive needs to have a good stress relaxation property, and cannot be too soft to result in insufficient cohesion to cause the deterioration to generate bubbles at high temperature.

Although the properties of the conventional pressure sensitive adhesives for adhering optical films, such as elasticity and adhesion, may gradually change with the temperature increased, the range of the changed properties are not significant enough to distinguish the differences between those at lower temperature, that is at room temperature, and those at high temperature in order to meet the different requirements. It is known that use of higher molecular weight polymers, addition of hardening monomers, such as hardening copolymerizable monomers containing nitrogen atoms to harden the adhesive and increase elasticity thereof, addition of more crosslinking agents or more silane coupling agents are often used to increase the elasticity and modulus of pressure-sensitive adhesives. However, although the abovementioned methods are able to provide an adhesive with lowering glue-overflow for a better processability at room temperature and a deterioration resistance for high stability at high temperature, the step filling ability at room temperature and the stress relaxation at high temperature will be declined and mura may appear after a high temperature test. On the other hand, use of low molecular weight polymer, and decreasing the amount of hardening monomer, crosslinking agent or silane coupling agent in the pressure sensitive adhesives may increase the flowability of the pressure sensitive adhesive, which may cause the glue-overflow during cutting process at room temperature and may cause the decomposition of small molecules in the adhesive to generate bubbles at high temperature.

Therefore, the conventional pressure sensitive adhesive is unable to apply for bonding the interface with step portion between a polymer optical film and a cover glass plate. The present invention is to provide an optical adhesive composition and an optical adhesive film prepared therefrom, the optical adhesive film has good step-filling ability and processability at room temperature and a deterioration resistance at high temperature, also a better stress relaxation.

### SUMMARY OF THE INVENTION

The present invention discloses an optical adhesive composition and an optical adhesive film prepared from photo-curing the optical adhesive composition. The disclosed optical adhesive film is able to bond the interface with step portion between an optical film and a cover glass plate.

The present invention is to provide an optical adhesive composition comprising an acrylic prepolymer, a crosslinking agent composition, a silane coupling agent and a photoinitiator, wherein the crosslinking agent composition comprises 30 percent to 90 percent by weight of an organic crosslinking agent with a reactive functionality of 3 or more and 70 weight percent to 10 weight percent of an organic crosslinking agent with a reactive functionality of less than 3.

In a preferred embodiment of the optical adhesive composition of the present invention, the amount of the crosslinking agent composition is 0.04 to 0.8 parts by weight per hundred parts by weight of the acrylic prepolymer.

In a preferred embodiment of the optical adhesive composition of the present invention, the amount of the silane coupling agent is 0.03 to 0.06 parts by weight per hundred parts by weight of the acrylic prepolymer.

In a preferred embodiment of the optical adhesive composition of the present invention, the amount of the photoinitiator is 0.05 to 0.15 parts by weight per hundred parts by weight of the acrylic prepolymer.

In a preferred embodiment of the optical adhesive composition of the present invention, the optical adhesive composition further comprises a curable copolymerizable monomer with a vinyl group, a ketone group or an aldehyde group.

In an embodiment of the optical adhesive composition of the present invention, the optical adhesive composition comprises 85 to 95 parts by weight of the acrylic prepolymer, 5 to 15 parts by weight of a curable copolymerizable monomer, 0.001 to 0.005 parts by weight of a chain transfer agent and 0.01 to 0.08 parts by weight of a photoinitiator.

In an embodiment of the optical adhesive composition of the present invention, the weight-average molecular weight (Mw) of the acrylic prepolymer is ranging between 900,000 and 1,500,000.

In an embodiment of the optical adhesive composition of the present invention, the polydispersity index (PDI) of the acrylic prepolymer is ranging between 1.5 and 2.5.

In an embodiment of the optical adhesive composition of the present invention, the viscosity of the acrylic prepolymer is ranging between 1500 mPa·s and 3000 mPa·s, and the non-volatile content thereof is 10% to 20%,

Another aspect of the present invention is to provide an optical adhesive film prepared by photo-curing the present optical adhesive composition, wherein the creep rate of the optical adhesive film is 6% to 11% at 25° C. and is 10% to 25% at 80° C., the recovery rate thereof is 75% to 90.5% at 25° C. and is 91% to 99%, at 80° C.

In an embodiment of the optical adhesive film of the present invention, the gel fraction of the optical adhesive film is 60% to 80%.

In an embodiment of the optical adhesive film of the present invention, the thickness of the optical adhesive film is 50 μm to 300 μm.

The above and other aspects of the invention will become better understood with regard to the following detailed description of the preferred but non-limiting embodiment(s). These and other aspects of the invention will become apparent from the following description of the presently preferred embodiments. The detailed description is merely illustrative of the invention and does not limit the scope of the invention, which is defined by the appended claims and equivalents thereof. As would be obvious to one skilled in the art, many variations and modifications of the invention may be affected without departing from the spirit and scope of the novel concepts of the disclosure.

### DETAILED DESCRIPTION OF THE INVENTION

In the following detailed description, for purposes of explanation, numerous specific details are set forth in order to provide a thorough understanding of the disclosed embodiments. It will be apparent, however, that one or more embodiments may be practiced without these specific details.

It is apparent that departures from specific designs and methods described and shown will suggest themselves to those skilled in the art and may be used without departing from the spirit and scope of the invention. The present invention is not restricted to the particular constructions described and illustrated, but should be construed to cohere with all modifications that may fall within the scope of the appended claims.

Unless defined otherwise, all technical and scientific terms used herein have the same meaning as commonly understood by one of ordinary skill in the art to which this invention belongs. Generally, the nomenclature used herein and the laboratory procedures are well known and commonly employed in the art. Conventional methods are used for these procedures, such as those provided in the art and various general references. Where a term is provided in the singular, the inventors also contemplate the plural of that term. The nomenclature used herein and the laboratory procedures described below are those well-known and commonly employed in the art.

The term “acrylic” used herein refers to acrylic or methacrylic, and the term “acrylate” used herein refers to acrylate or methacrylate.

The present invention provides an optical adhesive composition and an optical adhesive film prepared from photo-curing the optical adhesive composition. The disclosed optical adhesive film is able to bond the interface with step portion between a polymer optical film and a cover glass plate and to provide a good step-filling performance and processability at room temperature, also a deterioration resistance and better stress relaxation at high temperature. The creep rate of the optical adhesive film prepared from photo-curing of the present optical adhesive composition is 6% to 11% at 25° C. and is 10% to 25% at 80° C., and the recovery rate at 80° C. thereof is greater than that at 25° C. thereof.

The present optical adhesive composition comprises an acrylic prepolymer, a crosslinking agent composition, a silane coupling agent and a photoinitiator, wherein the crosslinking agent composition comprises 30 wt % to 90 wt % of organic crosslinking agent with a reactive functionality of 3 or more and 70 wt % to 10 wt % of organic crosslinking agent with a reactive functionality of less than 3.

In a preferred embodiment of the optical adhesive composition of the present invention, the amount of the crosslinking agent composition is 0.04 to 0.8 parts by weight per hundred parts by weight of the acrylic prepolymer. Different from using the multifunctional metal ion crosslinking agent in the state of related art, the crosslinking agent composition used in the present optical adhesive composition comprises organic crosslinking agents with different functionalities, wherein the acrylic prepolymer and the organic crosslinking agent with reactive functionality of 3 or more in the crosslinking agent composition, after cured, can crosslink to form a multi-block acrylic polymer partially with multi-dimensional network crosslinking centers and therefore to provide the elasticity and recovery to the optical adhesive film. Different from the use of only monofunctional or bifunctional organic crosslinking agents, the monofunctional or bifunctional organic crosslinking agents are used to form long-chain polymer universally with partial side chains for homogeneously increasing the molecular weight of a polymer and also, different from the use of a multifunctional metal ion crosslinking agent which is used for forming a harder adhesive. The creep rate of the optical adhesive film prepared from the present optical adhesive composition is 6% to 11% and the recovery rate thereof is 75% to 90.5% at 25° C. The present optical adhesive film can provide a good processability at room temperature without glue-overflow during processing due to the specific but not too high creep rate thereof and provide an excellent step filling ability at the same thickness due to the not too high recovery rate thereof. In addition, the creep rate of the optical adhesive film prepared from the present optical adhesive composition is 10% to 25% and the recovery rate thereof is 91% to 99% at 80° C. The present optical adhesive film provides high creep rate at high temperature so as to be able to absorb the transverse stress which cause the shrinkage of the polymer film, and thus, to inhibit mura appeared on the display due to the different stress and strain of the polymer films and the glass cover plate. Furthermore, because of the multi-dimensional network crosslinking structure in the present optical adhesive, even the present optical adhesive is softens and modulus thereof decreases at high temperature, the present optical adhesive have a better recovery rate than that at room temperature so as to avoid the generation of bubbles due to the deterioration of the unpolymerized small molecules.

The thickness of the present optical adhesive film can be various according to the practical use in the range between 50 μm and 300 μm and preferably in the range between 100 μm and 300 μm for covering and filling the step portion of the cover glass plate with various conventional thicknesses of ink printing.

Moreover, the gel fraction of the present optical adhesive film is from 60% to 80%. The gel fraction can be regarded as the ratio of the crosslinked network in the present optical adhesive film. Excessive cross-linked network will cause the hardness of the optical adhesive film too high to be detrimental to the step filling ability at room temperature and the stress relaxation at high temperature. An insufficient cross-linked network in the optical adhesive film will cause the hardness thereof too low to be largely varied with the change of temperature, and further, which results in unsatisfied processability at room temperature and poor recovery and cohesion at high temperature.

The storage modulus of the present optical adhesive film is 35 kPa to 90 kPa at 25° C., and the storage modulus at 80° C. thereof is 10 kPa to 20 kPa.

The crosslinking agent composition in the optical adhesive composition of the present invention comprises the crosslinking agents having functional groups that can react with the crosslinkable functional groups of the acrylic prepolymer. The functional groups of the crosslinking agents can be such as, but not limited to hydroxyl group, carboxyl group, mercapto group, amino group, isocyanate group or unsaturated hydrocarbons.

In a preferred embodiment of the optical adhesive composition of the present invention, the organic crosslinking agent with a reactive functionality of 3 or more in the crosslinking agent composition can be an organic crosslinking agent having 3 or 4 mercapto groups, such as but not limited to trimethylolpropane tris(3-mercaptopropionate), 2,3-dithio(2-mercapto)-1-propanethiol, tris[2-(3-mercaptopropionyloxy)ethyl] isocyanurate or pentaerythritol mercaptopropionate. The organic crosslinking agent with a reactive functionality of 3 or more suitably used in the crosslinking agent composition of the present optical adhesive composition can be commercially available products, such as “Thiocure® 440”, “Thiocure® 430” or “Thiocure® 333” manufactured by Bruno Bock Chemicals, Germany, or “Polythiol™ QE-340M” manufactured by Toray Fine Chemical Co. Ltd, Japan.

In a preferred embodiment of the optical adhesive composition of the present invention, the organic crosslinking agent with a reactive functionality of less than 3 in the crosslinking agent composition can be those commonly used for polymerization of (meth)acrylate in the related art, such as, but not limited to dihexanediol (meth)acrylate, polyethylene glycol diacrylate, or trimethylolpropane triacrylate.

The silane coupling agent in the present optical adhesive composition is used for adjusting the adhesion of the present optical adhesive film to the substrate, such as glass. The suitable silane coupling agent used in the present optical adhesive composition can be a silicone compound having epoxy groups such as (3-glycidoxypropyl)trimethoxysilane, (3-glycidoxypropyl)triethoxysilane or 2-(3,4-epoxycyclohexyl)ethyltrimethoxy silane; or a silicone compound having mercapto group, such as 3-mercaptopropyltrimethoxysilane, 3-mercaptopropyltriethoxysilane or 3-mercaptopropylmethyldimethoxysilane. The silane coupling agent can be commercially available products, such as “KBM-803” or “KBM-403” manufactured by Shin-Etsu Chemical Co., Ltd., Japan. In the optical adhesive composition of the present invention, the amount of the silane coupling agent is 0.03 to 0.06 parts by weight per hundred parts by weight of the acrylic prepolymer.

In a preferred embodiment of the optical adhesive composition of the present invention, a photoinitiator is added to trigger the reaction of the acrylic prepolymer, the crosslinking agent composition and the silane coupling agent. The photoinitiator can be those commonly used in the related art, such as, but not limited to acetophenone initiators, diphenyl ketone initiators, propiophenone initiators, dibenzoyl initiators, difunctional α-hydroxyketone initiators, acyl phosphine oxides or a combination thereof. In an embodiment of the present invention, the photoinitiator is diphenyl(2,4,6-trimethylbenzoyl)phosphine oxide. In an embodiment of the present invention, the amount of the photoinitiator is 0.05 to 0.15 parts by weight, and preferably is 0.06 to 0.12 parts by weight per hundred parts by weight of the acrylic prepolymer.

In another embodiment of the optical adhesive composition of the present invention, the optical adhesive composition can further comprise a curable copolymerizable monomer with a vinyl group, a ketone group or an aldehyde group. The amount of the curable copolymerizable monomer is less than 15 parts by weight per hundred parts by weight of the acrylic prepolymer, and preferably is 1 to 12 parts by weight per hundred parts by weight of the acrylic prepolymer. The curable copolymerizable monomer suitably used in the present optical adhesive composition can be, such as, but not limited to vinyl-containing monomers like acrylamide, methacrylamide, diacetone acrylamide, styrene, vinyltoluene or vinyl acetate; ketone-containing monomers like N-vinylpyrrolidone, 1-methyl-3-methylene-2-pyrrolidone, 1-methyl-5-methylene-2-pyrrolidone, 5-methyl-3-methylene-2-pyrrolidone, 1-n-propyl-5-methylene-2-pyrrolidone, 1-isopropyl-3-methylene-2-pyrrolidone or 1-isopropyl-5-methylene-2-pyrrolidone; or aldehyde-containing monomers like cetaldehyde, propionaldehyde, butyraldehyde, furaldehyde or benzaldehyde. The aforementioned curable copolymerizable monomers can be used alone or in combinations.

The acrylic prepolymer of the present optical adhesive composition comprises an acrylic monomer, a curable copolymerizable monomer, a chain transfer agent and a photoinitiator. The weight-average molecular weight (Mw) of the acrylic prepolymer is ranging between 9,000,00 and 1,500,000, and preferably ranging between 1,000,000 and 1,400,000, and the polydispersity index (PDI) thereof is ranging between 1.5 and 2.5. The polydispersity index (PDI) refers to the ratio of weight-average molecular weight (Mw) to number-average molecular weight (Mn) to indicate the distribution of the molecular weight of polymer chains in the polymer. As the PDI increases, the inhomogeneity of the crosslink state, the network formation, the chain length, the branching and the hyperbranching therein will be more randomly arranged. The present optical adhesive composition comprising the acrylic prepolymer with the aforementioned weight-average molecular weight (Mw) and polydispersity index (PDI) will make the optical adhesive film obtained after curing the optical adhesive composition have different properties at high temperature and at low temperature in order to meet the application requirements. In the present optical adhesive composition, if the PDI of the acrylic prepolymer is less than 1.5, the properties required respectively at high temperature and at low temperature are unable to be satisfied; if the PDI of the acrylic prepolymer is more than 2.5, although the different properties required respectively at high temperature and at low temperature may be both obtained, the variability of the properties at high temperature and at low temperature will be out of the range which can be controlled.

In the optical adhesive composition of the present invention, the viscosity of the acrylic prepolymer is ranging between 1500 mPa·s and 3000 mPa·s, and the non-volatile content thereof is 10% to 20%. The non-volatile content is measured by determining the residue portion of the non-volatile part of the optical adhesive composition after drying at 150° C. for 30 minutes, which refers to the content of the polymer having above a specific molecular weight, polymerized by the acrylic monomers with different functionality groups, the curable copolymerizable monomers, the chain transfer agent and the photoinitiator. The optical adhesive composition is controlled to have desired viscosity and non-volatile content for providing subsequently a preferable processing range to achieve an optical adhesive film with an expected creep rate and a recovery rate.

In an embodiment of the optical adhesive composition of the present invention, the acrylic prepolymer comprises 85 to 95 parts by weight of an acrylic monomer, 5 to 15 parts by weight of a curable copolymerizable monomer, 0.001 to 0.005 parts by weight of a chain transfer agent and 0.01 to 0.08 parts by weight of a photoinitiator.

In a preferred embodiment of the optical adhesive composition of the present invention, the acrylic prepolymer can comprise one or more acrylic monomer, and the suitable monomer can be alkyl acrylate, hydroxy acrylic monomer or furanyl acrylic monomer. In a preferred embodiment, the acrylic monomer comprises 60 to 75 parts by weight of alkyl acrylate, 5 to 18 parts by weight of a hydroxy acrylic monomer and 14 to 30 parts by weight of a furanyl acrylic monomer.

The alkyl acrylate suitable for acrylic prepolymer can be selected from those commonly used in the related art, such as but not limited to methyl acrylate, ethyl acrylate, propyl acrylate, isopropyl acrylate, n-butyl acrylate, isobutyl acrylate, n-pentyl acrylate, n-octyl acrylate, isooctyl acrylate, decyl acrylate, 2-doecyl acrylate, lauryl acrylate, 2-ethylhexyl acrylate or a combination thereof.

The hydroxy acrylic monomer used in the acrylic prepolymer for the optical adhesive composition can impart the optical adhesive film prepared therefrom a better water vapor permeability. Therefore, when the present optical adhesive film is applied to bond a cover glass plate to a display surface, because the optical adhesive film is located at the outer surface of the display and has a certain thickness, a hydroxy acrylic monomer in the acrylic monomer of the acrylic prepolymer can provide a better water vapor permeability to the optical adhesive film to avoid blur caused by the moisture and enhance the durability. However, if the amount of the hydroxy acrylic monomer added in the optical adhesive composition is exceeded, too much hydrogen bonds will be generated between the polymer chains to cause the decreased creep rate and the increased recovery of the optical adhesive film, which will be detrimental to the step filling ability and the stress relaxation at high temperature. The hydroxy acrylic monomer suitable for acrylic prepolymer can be, such as, but not limited to hydroxyethyl acrylate, 4-hydroxybutyl acrylate, 2-hydroxypropyl acrylate, 2-hydroxy-2-butyl acrylate, 1,4-cyclohexanedimethanol acrylate, 1-chloro-2-hydroxypropyl acrylate, pentaerythritol triacrylate, dipentaerythritol pentaacrylate or a combination thereof.

The furanyl acrylic monomer used in the acrylic prepolymer for a solvent-free formulation of the present optical adhesive composition is to provide the optical adhesive film prepared therefrom a better etching solubility to polymer substrates to enhance the adhesion. When the amount of the furanyl acrylic monomer is less, the adhesion of the optical adhesive film to the polymer substrate is insufficient. When the amount of the furanyl acrylic monomer is exceeded, the adhesion of the optical adhesive film to the polymer substrate may be too high to be hard to rework. The furanyl acrylic monomer suitable for acrylic prepolymer can be, such as, but not limited to tetrahydrofuryl acrylate, propyl 2-furanacrylate, pentyl 2-furanacrylate or a combination thereof.

The curable copolymerizable monomer suitably used in the acrylic prepolymer can be monomers containing vinyl groups, ketone groups, aldehyde groups, such as, but not limited to, vinyl-containing monomers like acrylamide, methacrylamide, diacetone acrylamide, styrene, vinyltoluene or vinyl acetate; ketone-containing monomers like N-vinylpyrrolidone, 1-methyl-3-methylene-2-pyrrolidone, 1-methyl-5-methylene-2-pyrrolidone, 5-methyl-3-methylene-2-pyrrolidone, 1-n-propyl-5-methylene-2-pyrrolidone, 1-isopropyl-3-methylene-2-pyrrolidone or 1-isopropyl-5-methylene-2-pyrrolidone; or aldehyde-containing monomers like cetaldehyde, propionaldehyde, butyraldehyde, furaldehyde or benzaldehyde. The aforementioned curable copolymerizable monomers can be used alone or in combinations.

In the optical adhesive composition of the present invention, the chain transfer agent is used to control the molecular weight and the PDI of the acrylic prepolymer and obtain the satisfied viscosity and non-volatile content. The chain transfer agent suitably used in the free radical reaction can be aliphatic mercaptans with different number of carbons or sulfur-free chain transfer agent selected in accordance with the temperature used in and the speed of the reaction. The sulfur-free chain transfer agent can be aniline, such as N,N-dimethylaniline and N,N-diethylaniline; terpene, such as α-pinene and terpinolene; styrenes, such as α-methylstyrene and α-methylstyrene dimer; compounds with benzylidene groups, such as dibenzylideneacetone, cinnamyl alcohol and cinnamaldehyde; hydroquinones, such as hydroquinone and dihydroxynaphthalene; olefins, such as 2,3-dimethyl-2-butene and 1,5-cyclooctadiene; alcohols such as phenol, benzyl alcohol and allyl alcohol; benzyl hydrocarbons, such as diphenylbenzene and triphenylbenzene. In an embodiment of the present invention, the chain transfer agent is α-methylstyrene dimer, that is mercaptan-free and odorless.

The photoinitiator suitable for the acrylic prepolymer in the present optical adhesive composition can be those commonly used in the related art, such as, but not limited to acetophenone initiators, diphenyl ketone initiators, propiophenone initiators, dibenzoyl initiators, difunctional α-hydroxy ketone initiators, acyl phosphine oxide initiators or the like. The aforementioned photoinitiators can be used alone or in combination. In an embodiment of the present invention, the photoinitiator is the combination of 1-hydroxycyclohexylbenzophenone and benzoin dimethyl ether.

The present optical adhesive composition can further comprise functional additives commonly used in the related art optionally, such as UV absorber, antistatic agent, anti-blue light agent, antioxidant, anti-glare agent, refractive index adjuster or the like. The selection of the functional additives is dependent on the product application field of the optical adhesive film. The additives are present in an amount without substantially affecting the optical properties of the optical adhesive film and the amount can be determined by the person skilled in the art.

The optical adhesive composition of the present invention is prepared by mixing the acrylic monomer, the curable copolymerizable monomer, the chain transfer agent and the photoinitiator evenly, irradiating and partially curing the mixture to obtain an acrylic prepolymer; adding the crosslinking agent composition, the silane coupling agent and the photoinitiator to the acrylic prepolymer to mix evenly to form an optical adhesive composition.

The optical adhesive film of the present invention is prepared by coating the optical adhesive composition to an optical base film or a release film, and irradiating the coating adhesive composition with UV light to form an optical adhesive film.

The thickness of the optical adhesive film prepared from the present optical adhesive composition is 50 μm to 300 μm and preferably is 100 μm to 250 μm.

The present invention will be explained in further detail with reference to the examples. However, the present invention is not limited to these examples.

### EXAMPLE

### Preparation Example 1: Preparation of Acrylic Prepolymer I

63 parts by weight of 2-ethylhexyl acrylate, 19 parts by weight of tetrahydrofuryl acrylate, 5 parts by weight of 4-hydroxybutyl acrylate (4-HBA), 13 parts by weight of N-vinylpyrrolidone, 0.0025 parts by weight of chain transfer agent of α-methylstyrene dimer, 0.034 parts by weight of photoinitiator (Doublecure-184, available from Double Bond Chemical Industry, Taiwan) and 0.034 parts by weight of photoinitiator (Doublecure-651, available from Double Bond Chemicals, Taiwan) were mixed under nitrogen atmosphere for 1 hour, and irradiated with UV light to trigger partial photopolymerization to prepare an acrylic prepolymer I with a weight-average molecular weight of 1,090,000, a PDI of 1.82 and a non-volatile content of 13.8%.

### Preparation Example 2: Preparation of Acrylic Prepolymer II

60 parts by weight of 2-ethylhexyl acrylate, 19 parts by weight of tetrahydrofuryl acrylate, 10 parts by weight of 4-hydroxybutyl acrylate (4-HBA), 11 parts by weight of N-vinylpyrrolidone, 0.0025 parts by weight of chain transfer agent of α-methylstyrene dimer, 0.034 parts by weight of photoinitiator (Doublecure-184) and 0.034 parts by weight of photoinitiator (Doublecure-651) were mixed under nitrogen atmosphere for 1 hour, and irradiated with UV light to trigger partial photopolymerization to prepare an acrylic prepolymer II with a weight-average molecular weight of 1,200,000, a PDI of 2.4 and a non-volatile content of 12.2%.

### Preparation Example 3: Preparation of Acrylic Prepolymer III

63 parts by weight of 2-ethylhexyl acrylate, 14 parts by weight of tetrahydrofuryl acrylate, 10 parts by weight of 4-hydroxybutyl acrylate (4-HBA), 13 parts by weight of N-vinylpyrrolidone, 0.0025 parts by weight of α-methylstyrene dimer of chain transfer agent, 0.034 parts by weight of photoinitiator (Doublecure-184) and 0.034 parts by weight of photoinitiator (Doublecure-651) were mixed under nitrogen atmosphere for 1 hour, and irradiated with UV to trigger partial photopolymerization to prepare an acrylic prepolymer III with a weight-average molecular weight of 1,250,000, a PDI of 1.87 and a non-volatile content of 12.0%.

### Example 1

100 parts by weight of acrylic prepolymer I prepared from the Preparation Example 1, 0.08 parts by weight of 1,6-hexanediol diacrylate, 0.04 parts by weight of organic crosslinking agent (Thiocure® 440, reactive functionality of 4, available from Bruno Bock Chemicals, Germany), 0.05 parts by weight of silane coupling agent (KBM-803, available from Shin-Etsu Silicone, Japan) and 0.06 parts by weight of photoinitiator (Doublecure-TPO, available from Double Bond Chemicals, Taiwan) were well mixed to obtain an optical adhesive composition.

Coating the obtained optical adhesive composition on a release film and irradiating with UV light with a wavelength of 365 nm to obtain an optical adhesive film with a thickness of 250 μm. The properties of the obtained optical adhesive film were determined in accordance with the measurements described hereinafter and shown in Table 1.

Gel fraction measurement: 200 mg of the optical adhesive film was removed from the release film as a sample and soaked in 25 ml ethyl acetate for 16 hours at room temperature. The sample was filtered via a stainless steel wire mesh of 200-mesh and dried at 150° C. for 20 minutes. The gel fraction was calculated by the following formula.

$$Gel fraction ( \% ) = ( The weight of the sample$$

$$after soaking / The weight of \text{} the sample before soaking ) ⋆ 100 \%$$

Creep rate and recovery rate measurement: An optical adhesive film laminated to 1 mm in thickness was prepared as a sample. The creep rate and recovery rate were measured by a Rheometer AR2000, available from TA Instruments, USA, under the following conditions.
Measurement temperature: 25° C. and 80° C.
Measurement pressure: 5*10⁴ MPa
Measurement time: 10 minutes each for creep and recovery
   After the measurements were completed, the maximum creep rate at 25° C. and 80° C. were recorded to represent the respective creep rate values at that temperature. The recovery rate was calculated by the following formula to obtain the recovery rate at different temperatures.

$$Recovery rate ( \text{} \% ) =$$

$$[ ( The maximum creep rate - The creep rate after recovering )$$

$$/ The maximum creep rate ] ⋆ 100 \%$$

Adhesion measurement: A 25 mm*100 mm optical adhesive film was adhered to a polyethylene terephthalate film of 38 μm. According to the test method of JIS Z0237, the optical adhesive film was adhered to a glass substrate after removing the release film, the adhesion was measured at a tensile speed of 300 mm/min and a peel angle of 180 degrees.

Processability at room temperature evaluation: An sample was cut off from the optical adhesive film by knife. The sample was observed under an electron microscope. If there was no optical adhesive out of the release film on the cutting edge, it was marked as “◯”; if optical adhesive out of the release film on the cutting edge, a glue-overflow was showed, it was marked as “X”.

Step filling ability evaluation: An glass cover plate and a glass having an ink-printing of 16 μm thickness was bonded by an optical adhesive film, and then, pressurized and debubbled under a pressure of 5 kgf/cm² at 50° C. for 20 minutes. The sample was furtherly stood at room temperature for one day and observed whether bubbles appears around the ink due to the poor filling of the optical adhesive film. If there were no bubbles appeared, it was marked as “O”; if there were bubbles appeared, it was marked as “X”.

Mura at high temperature evaluation: The optical adhesive film was used to bond a glass cover plate to a 9-inch automotive LC display (C090EAN02.0, available from AUO, Taiwan), the surface protective layer of the LC display has been removed. The obtained display was placed under an atmosphere of 105° C. for 1000 hours. Next, the display was observed at bright state of L255 and at the dark state of LO from 0 degree and 60 degree viewing angle, respectively, for evaluating the influence of high temperature to the optical adhesive film on mura occurrence. If no mura was appeared, it was marked as “◯”; if no significant mura was appeared, it was marked as “Δ”; if significant mura was appeared, it was marked as “X”.

### Example 2

An optical adhesive composition and an optical adhesive film were prepared by the manner same as the Example 1, except that the acrylic prepolymer II prepared from the Preparation Example 2 was used as acrylic prepolymer.

The properties of the optical adhesive film obtained from Example 2 were determined according to the test methods of Example 1 and shown in Table 1.

### Example 3

An optical adhesive composition and an optical adhesive film were prepared by the manner same as the Example 1, except that the acrylic prepolymer III prepared from the Preparation Example 3 was used as acrylic prepolymer.

The properties of the optical adhesive film obtained from Example 3 were determined according to the test methods of Example 1 and shown in Table 1.

### Example 4

An optical adhesive composition and an optical adhesive film were prepared by the manner same as the Example 2, except that the amount of 1,6-hexanediol diacrylate was 0.06 parts by weight, and 0.5 parts by weight of a UV absorber (EV82, available from Everlight Chemical Industrial Corp, Taiwan) was added.

The properties of the optical adhesive film obtained from Example 4 were determined according to the test methods of Example 1 and shown in Table 1.

### Example 5

An optical adhesive composition and an optical adhesive film were prepared by the manner same as the Example 2, except that the amount of 1,6-hexanediol diacrylate was 0.04 parts by weight.

The properties of the optical adhesive film obtained from Example 5 were determined according to the test methods of Example 1 and shown in Table 1.

### Example 6

An optical adhesive composition and an optical adhesive film were prepared by the manner same as the Example 2, except that the amount of silane coupling agent (KBM-803) was 0.03 parts by weight.

The properties of the optical adhesive film obtained from Example 6 were determined according to the test methods of Example 1 and shown in Table 1.

### Comparative Example 1

An optical adhesive composition and an optical adhesive film were prepared by the manner same as the Example 2, except that the amount of 1,6-hexanediol diacrylate was 0.12 parts by weight.

The properties of the optical adhesive film obtained from Comparative Example 1 were determined according to the test method of Example 1 and shown in Table 1.

TABLE 1
The properties of the optical adhesive film obtained
from Examples 1 to 6 and Comparative Example 1

| | | Example | Example | Example | Example | Example | Example | Comparative |
|---|---|---|---|---|---|---|---|---|
| | | 1 | 2 | 3 | 4 | 5 | 6 | Example 1 |
| Gel Fraction (%) | | 68.0 | 70.2 | 70.5 | 68.4 | 62.9 | 76.3 | 81.3 |
| Creep | 25° C. | 9.2 | 8.2 | 8.5 | 9.2 | 10.5 | 7.8 | 5.2 |
| Rate (%) | 80° C. | 15.7 | 13.0 | 11.8 | 17.4 | 24.3 | 10.4 | 5.7 |
| Recovery | 25° C. | 82.6 | 86.3 | 86.1 | 82.8 | 79.3 | 90.2 | 93.7 |
| Rate (%) | 80° C. | 92.5 | 93.8 | 96.2 | 94.8 | 91.6 | 97.7 | 95.4 |

| | | | | | | | |
|---|---|---|---|---|---|---|---|
| Storage Modulus | 40 | 44 | 48 | 51 | 50 | 39 | 51 |
| at 25° C. (kPa) | | | | | | | |
| Storage Modulus | 12 | 14 | 18 | 14 | 13 | 13 | 16 |
| at 80° C. (kPa) | | | | | | | |
| Adhesion (gf/inch) | 3240 | 2890 | 2625 | 3235 | 3290 | 2233 | 1631 |
| Processability at | ◯ | ◯ | ◯ | ◯ | ◯ | ◯ | ◯ |
| Room Temperature | | | | | | | |
| Step Filling Ability | ◯ | ◯ | ◯ | ◯ | ◯ | ◯ | X |
| Mura at High | ◯ | ◯ | ◯ | ◯ | ◯ | ◯ | X |
| Temperature | | | | | | | |

### Example 7

100 parts by weight of acrylic prepolymer II prepared from the Preparation Example 2, 0.08 parts by weight of 1,6-hexanediol diacrylate, 0.12 parts by weight of organic crosslinking agent (Thiocure® 440), 0.05 parts by weight of silane coupling agent (KBM-403, available from Shin-Etsu Silicone, Japan), 0.06 parts by weight of photoinitiator (Doublecure-TPO) and 0.5 parts by weight of UV absorber (EV82) were mixed to obtain an optical adhesive composition.

The optical adhesive film was prepared by the same manner as the Example 2. The properties of the optical adhesive film obtained from Example 7 were determined according to the test methods of Example 1 and shown in Table 2.

### Example 8

An optical adhesive composition and an optical adhesive film were prepared by the same manner as the Example 7, except that the amount of organic crosslinking agent (Thiocure® 440) was 0.15 parts by weight, and no UV absorber (EV82) was added.

The properties of the optical adhesive film obtained from Example 8 were determined according to the test methods of Example 1 and shown in Table 2.

### Example 9

90 parts by weight of acrylic prepolymer II prepared from the Preparation Example 2, 10 parts by weight of N-vinylpyrrolidone, 0.08 parts by weight of 1,6-hexanediol diacrylate, 0.55 parts by weight of organic crosslinking agent (Thiocure® 333, reactive functionality of 3, available from Bruno Bock Chemicals, Germany), 0.05 parts by weight of silane coupling agent (KBM-403) and 0.06 parts by weight of photoinitiator (Doublecure-TPO) were mixed to obtain an optical adhesive composition.

The optical adhesive film was prepared by the same manner as the Example 2. The properties of the optical adhesive film obtained from Example 9 were determined according to the test methods of Example 1 and shown in Table 2.

### Comparative Example 2

90 parts by weight of acrylic prepolymer II prepared from the Preparation Example 2, 10 parts by weight of N-vinylpyrrolidone, 0.08 parts by weight of 1,6-hexanediol diacrylate, 0.08 parts by weight of organic crosslinking agent (Evabopol® 494, reactive functionality of 1, available from Bruno Bock Chemicals, Germany), 0.05 parts by weight of silane coupling agent (KBM-403) and 0.06 parts by weight of photoinitiator (Doublecure-TPO) were mixed to obtain an optical adhesive composition.

The optical adhesive film was prepared by the same manner as the Example 2. The properties of the obtained optical adhesive film were determined according to the test methods of Example 1 and shown in Table 2.

### Comparative Example 3

100 parts by weight of acrylic prepolymer II prepared from the Preparation Example 2, 0.08 parts by weight of 1,6-hexanediol diacrylate, 0.04 parts by weight of organic crosslinking agent (Evabopol® 494), 0.25 parts by weight of silane coupling agent (KBM-403) and 0.06 parts by weight of photoinitiator (Doublecure-TPO) were mixed to obtain an optical adhesive composition.

The optical adhesive film was prepared by the same manner as the Example 2. The properties of the obtained optical adhesive film were determined according to the test methods of Example 1 and shown in Table 2.

TABLE 2
The properties of the optical adhesive film obtained
from Examples 7 to 9 and Comparative Example 2 to 3

| | | | | | Comparative | Comparative |
|---|---|---|---|---|---|---|
| | | Example 7 | Example 8 | Example 9 | Example 2 | Example 3 |
| Gel Fraction (%) | | 78.4 | 74.0 | 67.5 | 72.3 | 77.8 |
| Creep | 25° C. | 7.9 | 9.8 | 6.1 | 4.5 | 5.8 |
| Rate (%) | 80° C. | 10.6 | 13.7 | 18.1 | 9.6 | 7.5 |
| Recovery | 25° C. | 86.1 | 85.4 | 78.2 | 87.7 | 89.7 |
| Rate (%) | 80° C. | 96.2 | 95.4 | 92.6 | 94.6 | 97.3 |

| | | | | | |
|---|---|---|---|---|---|
| Storage Modulus | 42 | 40 | 84 | 96 | 51 |
| at 25° C. (kPa) | | | | | |
| Storage Modulus | 13 | 11 | 18 | 22 | 18 |
| at 80° C. (kPa) | | | | | |
| Adhesion (gf/inch) | 2090 | 2426 | 3446 | 3925 | 2916 |
| Processability at | ◯ | ◯ | ◯ | ◯ | ◯ |
| room temperature | | | | | |
| Step Filling Ability | ◯ | ◯ | ◯ | X | X |
| Mura At High | ◯ | ◯ | ◯ | Δ | X |
| Temperature | | | | | |

As shown in Table 1 and Table 2, the creep rate at 25° C. of each optical adhesive film obtained from Examples 1 to 9 is ranging between 6.1% and 10.5%, the optical adhesive films can provide both processability and step filling ability at room temperature; and the creep rate at 80° C. thereof is ranging between 10.4% and 24.3% and the recovery rate at 80° C. thereof is greater than the recovery rate at 25° C. thereof, so that the optical adhesive film can be used to the glass cover plate without mura occurrence at high temperature. Therefore, the optical adhesive film prepared from the present optical adhesive composition has good step filling ability and processability at room temperature, a deterioration resistance at high temperature and better stress relaxation.

Although particular embodiments have been shown and described, it should be understood that the above discussion is not intended to limit the present invention to these embodiments. Persons skilled in the art will understand that various changes and modifications may be made without departing from the scope of the present invention as literally and equivalently covered by the following claims.

What is claimed is:

1. An optical adhesive composition, comprising:
100 parts by weight of an acrylic prepolymer;
0.04 to 0.8 parts by weight of a crosslinking agent composition;
0.03 to 0.06 parts by weight of a silane coupling agent; and
0.05 to 0.15 parts by weight of a photoinitiator;
wherein the crosslinking agent composition comprises 30 wt % to 90 wt % of an organic crosslinking agent with a reactive functionality of 3 or more, and 70 wt % to 10 wt % of an organic crosslinking agent with a reactive functionality of less than 3.

2. The optical adhesive composition as claimed in claim 1, wherein the optical adhesive composition comprises 100 parts by weight of the acrylic prepolymer, 0.08 to 0.7 parts by weight of the crosslinking agent composition, 0.03 to 0.05 parts by weight of the silane coupling agent and 0.06 to 0.12 parts by weight of the photoinitiator.

3. The optical adhesive composition as claimed in claim 1, wherein the crosslinking agent composition comprises an organic crosslinking agent containing a hydroxyl group, a carboxyl group, a mercapto group, an amino group, an isocyanate group or unsaturated hydrocarbons cross-linkable with the acrylic prepolymer.

4. The optical adhesive composition as claimed in claim 3, wherein the organic crosslinking agent with a reactive functionality of 3 or more is an organic crosslinking agent having 3 or 4 mercapto groups.

5. The optical adhesive composition as claimed in claim 4, wherein the organic crosslinking agent with a reactive functionality of 3 or more is trimethylolpropane triacrylate, 2,3-bis((2-mercaptoethyl)thio)-1-propanethiol, tris[2-(3-mercaptopropionyloxy)ethyl] isocyanurate or pentaerythritol mercaptopropionate.

6. The optical adhesive composition as claimed in claim 3, wherein the organic crosslinking agent with a reactive functionality of less than 3 is dihexanediol (meth)acrylate, polyethylene glycol diacrylate or trimethylolpropane triacrylate.

7. The optical adhesive composition as claimed in claim 1, wherein the silane coupling agent is a silicon compound having an epoxy group or a silicon compound having a mercapto group.

8. The optical adhesive composition as claimed in claim 7, wherein the silane coupling agent is (3-glycidoxypropyl)trimethoxysilane, (3-glycidoxypropyl)triethoxysilane, 2-(3,4-epoxycyclohexyl)ethyltrimethoxy silane, 3-mercaptopropyltrimethoxysilane, 3-mercaptopropyltriethoxysilane or 3-mercaptopropylmethyldimethoxysilane.

9. The optical adhesive composition as claimed in claim 1, wherein the photoinitiator is an acetophenone initiator, a diphenyl ketone initiator, a propiophenonetype initiator, a dibenzoyl initiator, a difunctional α-hydroxyketone initiator or acyl phosphine oxides.

10. The optical adhesive composition as claimed in claim 1, wherein the optical adhesive composition further comprises a curable copolymerizable monomer with a vinyl group, a ketone group or an aldehyde group.

11. The optical adhesive composition as claimed in claim 10, wherein the amount of the curable copolymerizable monomer with a vinyl group, a ketone group or an aldehyde group is 1 to 12 parts by weight per 100 parts by weight of the acrylic prepolymer.

12. The optical adhesive composition as claimed in claim 10, wherein the curable copolymerizable monomer with a vinyl group, a ketone group or an aldehyde group is acrylamide, methacrylamide, diacetone acrylamide, styrene, vinyltoluene, vinyl acetate, N-vinylpyrrolidone, 1-methyl-3-methylene-2-pyrrolidone, 1-methyl-5-methylene-2-pyrrolidone, 5-methyl-3-methylene-2-pyrrolidone, 1-n-propyl-5-methylene-2-pyrrolidone, 1-isopropyl-3-methylene-2-pyrrolidone, 1-isopropyl-5-methylene-2-pyrrolidone, acetaldehyde, propionaldehyde, butyraldehyde, furfural, benzaldehyde, or a combination thereof.

13. The optical adhesive composition as claimed in claim 1, wherein the acrylic prepolymer comprises 85 to 95 parts by weight of an acrylic monomer, 5 to 15 parts by weight of a curable copolymerizable monomer, 0.001 to 0.005 by weight of a chain transfer agent and 0.01 to 0.08 parts by weight of a photoinitiator.

14. The optical adhesive composition as claimed in claim 13, wherein the weight-average molecular weight (Mw) of the acrylic prepolymer is ranging between 900,000 and 1,500,000.

15. The optical adhesive composition as claimed in claim 13, wherein a polydispersity index (PDI) of the acrylic prepolymer is ranging between 1.5 and 2.5.

16. The optical adhesive composition as claimed in claim 13, wherein the acrylic monomer comprises 60 to 75 parts by weight of an alkyl acrylate, 5 to 18 parts by weight of a hydroxy acrylic monomer and 14 to 30 parts by weight of a furanyl acrylic monomer per 100 parts by weight of the acrylic monomer.

17. An optical adhesive film prepared by photocuring of the optical adhesive composition as claimed in claim 1, wherein a creep rate of the optical adhesive film is 6% to 11% at 25° C. and is 10% to 25% at 80° C., and a recovery rate at 80° C. thereof is greater than the recovery rate at 25° C. thereof.

18. The optical adhesive film as claimed in claim 17, wherein the recovery rate of the optical adhesive film is 75% to 90.5% at 25° C. and is 91% to 99% at 80° C.

19. The optical adhesive film as claimed in claim 18, wherein a gel fraction of the optical adhesive film is 60% to 80%.

20. The optical adhesive film as claimed in claim 17, wherein a thickness of the optical adhesive film is 50 μm to 300 μm.
